(19) United States
(12) Patent Application Publication
(10) Pub. No.: US 2014/0341106 A1
(43) Pub. Date: Nov. 20, 2014

(54) RADIO RELAY APPARATUS, WIRELESS COMMUNICATION METHOD AND PROCESSOR

(71) Applicant: KYOCERA CORPORATION, Kyoto (JP)

(72) Inventor: Kunihiko Bandoh, Yokohama-shi (JP)

(73) Assignee: KYOCERA CORPORATION, Kyoto (JP)

(21) Appl. No.: 14/367,369

(22) PCT Filed: Dec. 19, 2012
(86) PCT No.: PCT/JP2012/008136

§ 371 Date: Jun. 20, 2014

(30) Foreign Application Priority Data
Dec. 22, 2011 (JP) 2011-281917

(51) Int. Cl. H04B 7/155; H04W 16/26

(52) U.S. Cl. CPC H04B 7/15507; H04W 16/26
USPC 370/315

(57) ABSTRACT

Provided is radio relay apparatus which automatically determines value different from preamble indexes of peripheral radio base stations to be preamble index of the self apparatus, as well as such radio communication method and processor. Radio relay apparatus relays radio signals transmitted and received between radio base stations and radio terminal. Radio relay apparatus includes terminal side communicator that transmits and receives radio signals to and from radio terminal; base station side communicator that transmits and receives radio signals to and from radio base stations; and controllers and that set first preamble index, which is preamble index of radio relay apparatus, and that acquire, from radio signal received by the base station side communicator from each radio base station, second preamble index, which is preamble index of the radio base station. The controllers and determine value different from second preamble index to be first preamble index.

### CROSS-REFERENCES TO RELATED APPLICATIONS

This application claims priority to and the benefit of Japanese Patent Application No. 2011-281917 filed on Dec. 22, 2011, the entire contents of which are incorporated herein by reference.

### TECHNICAL FIELD

The present invention relates to a radio relay apparatus, a wireless communication method (which is also referred to as a radio communication method), and a processor.

### BACKGROUND

In order for radio terminals to communicate with radio base stations, the radio terminals have to be in a position within a range (service area) of reach of radio signals transmitted from the radio base stations. However, since there are numerous obstacles in mountainous areas and urban areas where high-rise buildings or the like are closely built together, in some places radio signal reception is poor. For the purpose of covering the places where radio signal reception is disturbed, radio relay apparatuses (repeaters) configured to relay radio signals between radio base stations and radio terminals are required.

Such a radio relay apparatus includes a donor node (base station side unit) and a service node (terminal side unit). The donor node is a unit configured to transmit and receive data to and from radio base stations, and the service node is a unit configured to transmit and receive data to and from radio terminals.

Radio terminals connected to a radio relay apparatus acquire a preamble contained in a downlink signal transmitted from the connected radio relay apparatus. Generally, a preamble is a known signal added to a head of a frame, and radio terminals acquire a preamble so as to establish timing synchronization.

A preamble is configured by a bit pattern that varies from one radio base station to another or from one radio relay apparatus to another, and bit patterns of different preambles are associated with preamble indexes. For example, in WiMAX®, preamble indexes in the range of 0-114 are defined.

When a preamble index of a radio relay apparatus connected to a radio terminal is the same value as a preamble index of one of peripheral radio base stations, the radio terminal might receive a radio signal from the peripheral radio base station, not from the connected radio relay apparatus.

Since a conventional radio relay apparatus is assigned with a fixed preamble index value, in order to prevent the situation where the assigned preamble index is the same as the preamble index of the peripheral base station, firstly, the preamble indexes of the peripheral base stations were checked, and subsequently, a radio relay apparatus having a different preamble index value was disposed.

### CITATION LIST

### Patent Literature

Patent Literature 1: Japanese Patent Application Publication No. 2011-91784

### SUMMARY OF INVENTION

### Technical Problem

However, it requires a lot of working time, when for example a radio relay apparatus is disposed, to check the preamble indexes of the peripheral radio base stations and to dispose a radio relay apparatus having a different preamble index value.

Furthermore, the position of the radio relay apparatus is subject to change after the radio relay apparatus has been disposed. As a result of the change in the position of the radio relay apparatus, the preamble index of the radio relay apparatus might overlap with the value of the preamble index value of another peripheral radio base station.

As a technology to prevent interference in a radio communication system including a radio relay apparatus, as in Patent Literature 1, an invention in which the radio relay apparatus controls handovers of a radio terminal is known.

However, handing over the radio terminal as in the invention disclosed in Patent Literature 1 does not effectively solve the problem that, when the preamble index of the radio relay apparatus inevitably overlaps with the value of the preamble index of the peripheral radio base station, the radio terminal connected to the radio relay apparatus erroneously receives data from the peripheral radio base station.

The present invention has been conceived in light of the above problems, and it is an objective thereof to provide a radio relay apparatus which is capable of automatically determining a value different from peripheral indexes of peripheral radio base stations to be the preamble index of the self apparatus, as well as such a radio communication method and such a processor.

### Solution to Problem

A first aspect of the present invention for achieving the above objective resides in a radio relay apparatus which relays radio signals transmitted and received between radio base stations and a radio terminal, including: a terminal side communicator that transmits and receives radio signals to and from the radio terminal; a base station side communicator which transmits and receives radio signals to and from the radio base stations; and a controller which sets a first preamble index, which is a preamble index of the radio relay apparatus, and that acquires, from a radio signal received by the base station side communicator from each of the radio base stations, a second preamble index, which is a preamble index of the radio base station, wherein the controller determines a value different from the second preamble index to be the first preamble index.

A second aspect of the present invention resides in the radio relay apparatus of the first aspect, wherein the controller is configured to: set a predetermined initial value as a candidate value for the first preamble index; compare the candidate value with the second preamble index; when a result of the comparison indicates that the candidate value is equal to the second preamble index, change the candidate value and compare the changed candidate value with the second preamble index again; and when the result of the comparison indicates that the candidate value is not equal to the second preamble index, determine the candidate value to be the first preamble index.

A third aspect of the present invention resides in the radio relay apparatus of the second aspect, wherein the predetermined initial value is calculated from a value of a MAC address of the radio relay apparatus.

A fourth aspect of the present invention resides in the radio relay apparatus of the first aspect, wherein the controller is configured to: set the first preamble index used during a previously established connection as a candidate value for the first preamble index; compare the candidate value with the second preamble index; when a result of the comparison indicates that the candidate value is equal to the second preamble index, change the candidate value and compare the changed candidate value with the second preamble index again; and when the result of the comparison indicates that the candidate value is not equal to the second preamble index, determine the candidate value to be the first preamble index.

A fifth aspect of the present invention resides in the radio relay apparatus of any one of the first to the fourth aspect, wherein the controller determines the first preamble index when detecting a predetermined event.

A sixth aspect of the present invention resides in the radio relay apparatus of the fifth aspect, wherein the detection of the predetermined event includes detection of an initial connection or a reconnection between the radio relay apparatus and the radio base station.

A seventh aspect of the present invention resides in the radio relay apparatus of the fifth aspect, wherein the detection of the predetermined event includes detection of a return from an idle state or a handover between the radio relay apparatus and the radio base station.

Although the solution of the present invention has been described above to be provided by an apparatus, it is to be understood that the present invention may also be achieved though a method, a program, and a storage medium storing a program that substantially correspond to the aforementioned aspects, and that the method, the program, and the storage medium are also included in the scope of the present invention.

For example, an eighth aspect of the present invention embodied by a method resides in a radio communication method for a radio relay apparatus which relays radio signals transmitted and received between radio base stations and a radio terminal. In the radio communication method, the radio relay apparatus includes a terminal side communicator which transmits and receives radio signals to and from the radio terminal, and a base station side communicator that transmits and receives radio signals to and from the radio base stations. The radio communication method includes the steps of: acquiring, from a radio signal received by the base station side communicator from each of the radio base stations, a second preamble index, which is a preamble index of the radio base station; and determining a value different from the second preamble index to be a first preamble index, which is a preamble index of the radio relay apparatus.

A ninth aspect of the present invention resides in the radio communication method of the eighth aspect, further including the steps of: setting a predetermined initial value as a candidate value for the first preamble index; comparing the candidate value with the second preamble index; when a result of the comparison indicates that the candidate value is equal to the second preamble index, changing the candidate value and comparing the changed candidate value with the second preamble index again; and when the result of the comparison indicates that the candidate value is not equal to the second preamble index, determining the candidate value to be the first preamble index.

A tenth aspect of the present invention resides in the radio communication method of the eighth aspect, further including the steps of: setting the first preamble index used during a previously established connection as a candidate value for the first preamble index; comparing the candidate value with the second preamble index; when a result of the comparison indicates that the candidate value is equal to the second preamble index, changing the candidate value and comparing the changed candidate value with the second preamble index again; and when the result of the comparison indicates that the candidate value is not equal to the second preamble index, determining the candidate value to be the first preamble index.

For another example, an eleventh aspect of the present invention embodied by a processor resides in a processor of a radio relay apparatus which relays radio signals transmitted and received between radio base stations and a radio terminal. The processor is configured to: set a first preamble index, which is a preamble index of the radio relay apparatus; acquire, from a radio signal received from each of the radio base stations, a second preamble index, which is a preamble index of the radio base station; and determine a value different from the second preamble index to be the first preamble index.

A twelfth aspect of the present invention resides in the processor of the eleventh aspect, further configured to: set a predetermined initial value as a candidate value for the first preamble index; compare the candidate value with the second preamble index; when a result of the comparison indicates that the candidate value is equal to the second preamble index, change the candidate value and compare the changed candidate value with the second preamble index again; and when the result of the comparison indicates that the candidate value is not equal to the second preamble index, determine the candidate value to be the first preamble index.

A thirteenth aspect of the present invention resides in the processor of the eleventh aspect, further configured to: set the first preamble index used during a previously established connection as a candidate value for the first preamble index; compare the candidate value with the second preamble index; when a result of the comparison indicates that the candidate value is equal to the second preamble index, change the candidate value and compare the changed candidate value with the second preamble index again; and when the result of the comparison indicates that the candidate value is not equal to the second preamble index, determine the candidate value to be the first preamble index.

### Advantageous Effects of Invention

According to the present invention, a radio relay apparatus which is capable of automatically determining a value different from peripheral indexes of peripheral radio base stations to be the preamble index of the self apparatus, as well as such a radio communication method and such a processor, is provided.

### BRIEF DESCRIPTION OF DRAWINGS

The present invention will be further described below with reference to the accompanying drawings, wherein:

FIG. 1 is a schematic diagram of a radio communication system according to one embodiment of the present invention;

FIG. 2 is a function block diagram illustrating a schematic structure of a radio relay apparatus according to one embodiment of the present invention;

FIG. 3 is a flowchart illustrating processing of determining a preamble index in a radio relay apparatus according to one embodiment of the present invention;

FIG. 4 illustrates sequence for determination of a preamble index at the time of an initialization in a radio relay apparatus according to one embodiment of the present invention;

FIG. 5 illustrates sequence for determination of a preamble index at the time of a reconnection in a radio relay apparatus according to one embodiment of the present invention; and

FIG. 6 illustrates sequence for determination of a preamble index at the time of a return from an idle state or a handover in a radio relay apparatus according to one embodiment of the present invention.

### DESCRIPTION OF EMBODIMENTS

One embodiment of the present invention will be described with reference to the accompanying drawings.

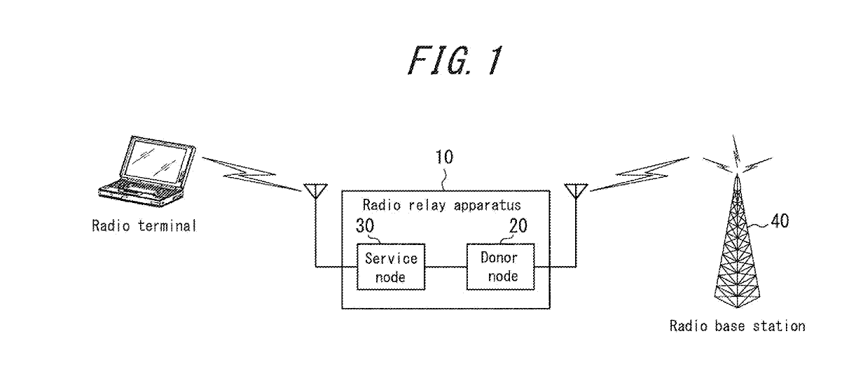

FIG. 1 is a schematic diagram of a radio communication system according to one embodiment of the present invention. The radio communication system includes a radio base station 40, a radio terminal, and a radio relay apparatus 10. The radio relay apparatus 10 relays data transmitted and received between the radio base station 40 and the radio terminal.

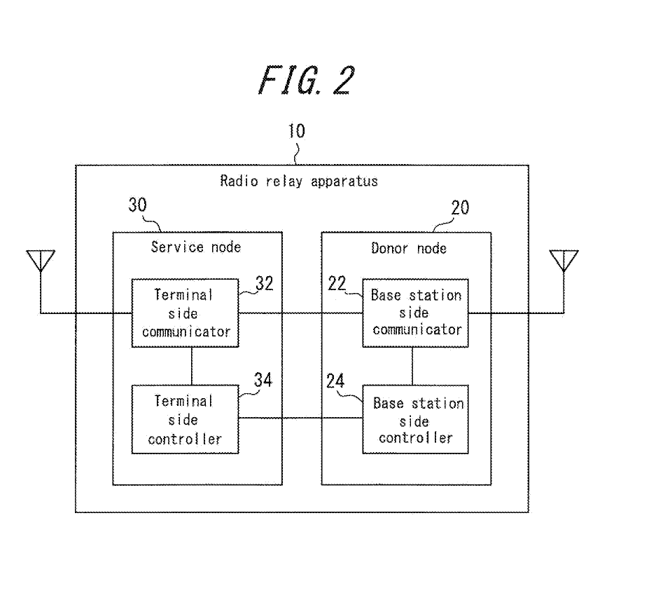

FIG. 2 is a function block diagram illustrating a schematic structure of a radio relay apparatus according to one embodiment of the present invention. The radio relay apparatus 10 includes a donor node 20 and a service node 30.

Firstly, a description is given of a function block of the donor node 20. The donor node 20 includes a base station side communicator 22 and a base station side controller 24.

The base station side communicator 22 transmits and receives data to and from the radio base station 40 via an antenna. As for downlink data, the base station side communicator 22 receives a radio signal from the radio base station 40 and downconverts the received radio signal to a baseband signal for output to the terminal side communicator 32. As for uplink data, the base station side communicator 22 receives the uplink data in the form of a baseband signal from the terminal side communicator 32 and upconverts the received baseband signal to a radio signal for transmission to the radio base station 40.

The base station side communicator 22 also receives radio signals from a plurality of peripheral radio base stations. The term “peripheral radio base station” herein encompasses a peripheral radio relay apparatus as well. The reason is that a service node included in a radio relay apparatus has substantially the same functions as those of a radio base station.

The base station side controller 24 controls the entire donor node 20 including the base station side communicator 22. The base station side controller 24 may be configured as software executed in any appropriate processor such as a CPU (Central Processing Unit) or may be configured by using dedicated processors (e.g. DSPs: Digital Signal Processors) each assigned to specific processing.

The base station side controller 24 also executes processing of establishing a connection between the donor node 20 and the radio base station 40 when detecting an event (which is referred to below as a “predetermined event”) such as an initial connection, a reconnection, a return from an idle state, a handover, or the like between the radio relay apparatus 10 and the radio base station 40.

The time of the “initial connection” herein refers to the time of a power-on or a reset, and the “reconnection” refers to reconnection of the radio relay apparatus 10 and the radio base station 40 after the connection therebetween has been disconnected for some reason. The “idle state” refers to a state where data transmission and reception is suspended for a power saving, and the term “handover” is used with a normal meaning of the term.

When establishing a connection between the donor node 20 and the radio base station 40, the base station side controller 24 determines a frequency of the donor node 20. The base station side controller 24 notifies the terminal side controller 34 of the determined frequency of the donor node 20.

The base station side controller 24 acquires a preamble from a radio signal received from each of the peripheral radio base stations, and the base station side controller 24 feeds the terminal side controller 34 a preamble index corresponding to the acquired preamble.

The base station side controller 24 includes a table in which bit patterns of preambles are associated with preamble indexes. With reference to the table, the base station side controller 24 associates the preamble acquired from the signal received from the peripheral radio base station with the corresponding preamble index.

Subsequently, a description is given of a function block of the service node 30. The service node 30 includes a terminal side communicator 32 and a terminal side controller 34.

As for downlink data, the terminal side communicator 32 receives the downlink data in the form of a baseband signal from the base station side communicator 22 and upconverts the received baseband signal to a radio signal for transmission to the radio terminal.

As for uplink data, the terminal side communicator 32 receives the uplink data in the form of a radio signal from the radio terminal and downconverts the received radio signal to a baseband signal for output to the base station side communicator 22.

The base station side controller 34 controls the entire service node 30 including the terminal side communicator 32. The terminal side controller 34 may be configured as software executed in any appropriate processor such as a CPU (Central Processing Unit) or may be configured by using dedicated processors (e.g. DSPs: Digital Signal Processors) each assigned to specific processing. Although the present embodiment illustrates the configuration in which the donor node 20 includes the base station side controller 24 and the service node 30 includes the terminal side controller 34 and thus, the donor node 20 and the service node 30 each have the controller, the present invention is not limited to the above configuration. For example, the donor node 20 and the service node 30 may be controlled by a single controller.

When detecting a predetermined event, the terminal side controller 34 receives the frequency of the donor node 20 that the base station side controller 24 has determined, and based on the received frequency of the donor node 20, the terminal side controller 34 determines an operating frequency of the service node 30.

The terminal side controller 34 determines the operating frequency of the service node 30, for example, before executing the processing of determining the preamble index of the radio relay apparatus 10.

The terminal side controller 34 acquires the preamble indexes of the peripheral radio base stations from the base station side controller 24. The terminal side controller 34 determines a preamble index different from the preamble indexes of the peripheral radio base stations to be the preamble index of the radio relay apparatus 10.

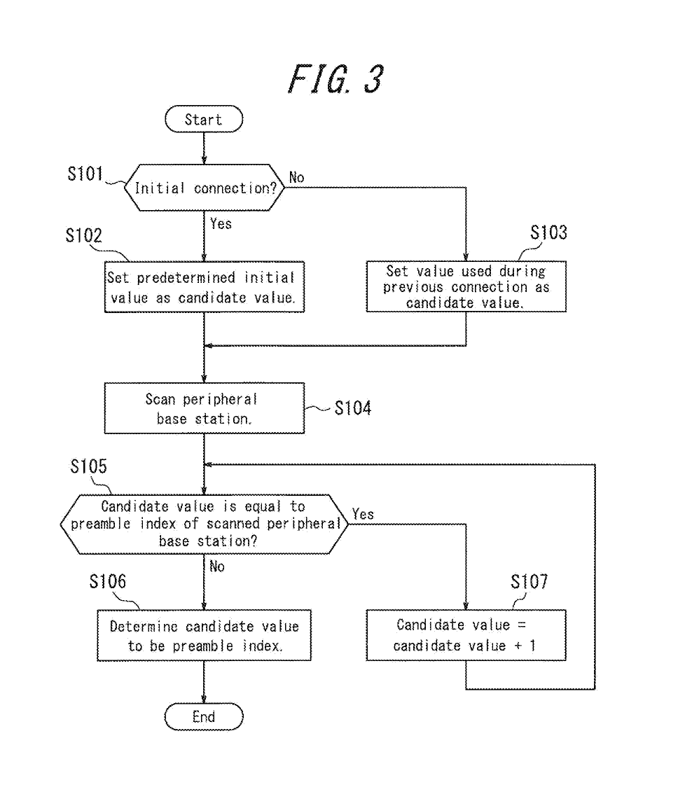

With reference to a flowchart of FIG. 3, a description is given of the processing performed by the radio relay apparatus 10 to determine the preamble index of the radio relay apparatus 10. The processing illustrated in the flowchart of FIG. 3 is executed, for example, after the terminal side controller 34 has determined the operating frequency of the service node 30.

The base station side controller 24 and the terminal side controller 34 regularly monitor predetermined events, and when a predetermined event is started, the base station side controller 24 and the terminal side controller 34 determines whether the started predetermined event is an initial connection (step S101).

When the started predetermined event is an initial connection in the step S101, the terminal side controller 34 sets a predetermined initial value as a candidate value for the preamble index (step S102). For example, the terminal side controller 34 may set a remainder obtained by dividing a value of an MAC address of the radio relay apparatus 10 by 114 to be the predetermined initial value. In case of WiMAX®, the value range for the preamble index is from 0-114. Accordingly, by calculating the predetermined initial value as described above, an appropriate value in the range of 0-114 may be randomly selected.

When the started predetermined event is not an initial connection in the step S101, the terminal side controller 34 sets a preamble index value used when the radio terminal was previously connected to the radio relay apparatus 10 as the candidate value for the preamble index (step S103).

The radio relay apparatus 10 searches for peripheral radio base stations, and the base station side controller 24 acquires a preamble of a radio signal received from each of the peripheral radio base stations and associates the acquired preamble with the corresponding preamble index (step S104).

The terminal side controller 34 receives the preamble index of the peripheral wireless base stations from the base station side controller 24 and compares the received preamble index with the candidate value for the preamble index (step S105).

When the candidate value for the preamble index is not equal to the value of the preamble index of the peripheral radio base station, the terminal side controller 34 determines the candidate value for the preamble index to be the preamble index of the radio relay apparatus 10 (step S106).

When the candidate value for the preamble index is equal to the value of the preamble indexes of the peripheral radio base station in the step S105, the terminal side controller 34 increments the candidate value for the preamble index by 1 (step S107). Then, processing returns to the step S105 where the terminal side controller 34 again compares the value of the preamble index of the peripheral radio base station with the incremented candidate value. Although in the step S107 the example of incrementing the candidate value for the preamble index by 1 is described, the method for changing the candidate value for the preamble index is not limited to the above example. For example, it is possible to increment the candidate value by any number greater than 1, such as 2 or 3, or to decrement the candidate value instead of incrementing.

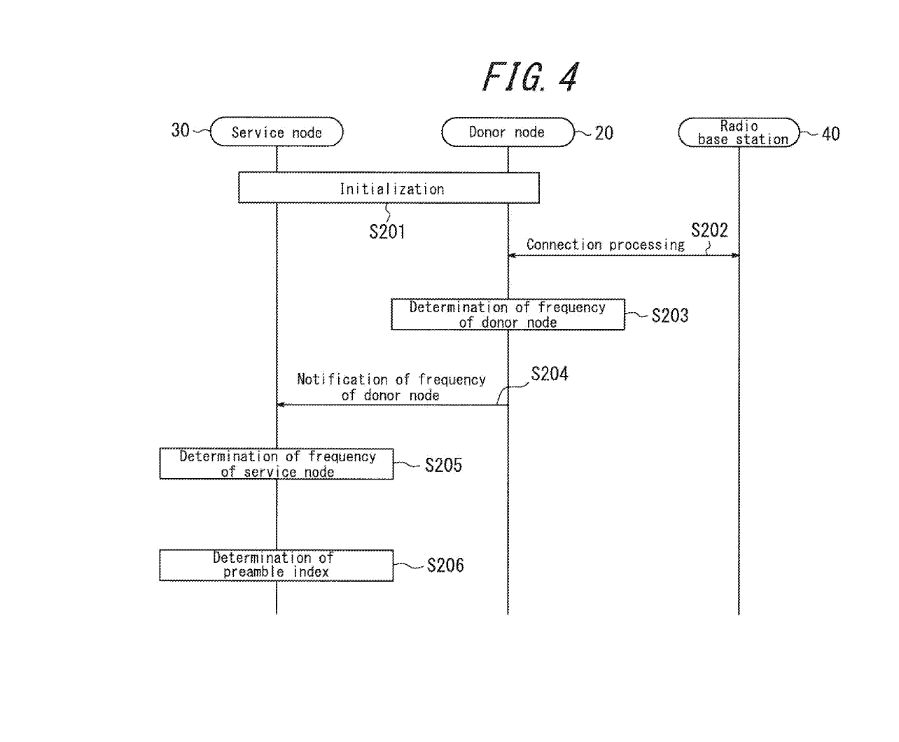

FIG. 4 illustrates sequence for the radio relay apparatus 10 to determine a preamble index at the time of an initial connection.

When the service node 30 and the donor node 20 are initialized due to a power-on or a reset (step S201), the base station side controller 24 included in the donor node 20 starts connection processing with the radio base station 40 (step S202), and the base station side controller 24 determines a frequency of the donor node 20 (step S203).

The terminal side controller 34 included in the service node 30 is notified by the base station side controller 24 of the frequency of the donor node 20 (step S204), and the terminal side controller 34 determines a frequency of the service node 30 (step S205).

When the frequency of the service node 30 is determined, the radio relay apparatus 10 executes the processing of determining the preamble index as illustrated in FIG. 3 (step S206).

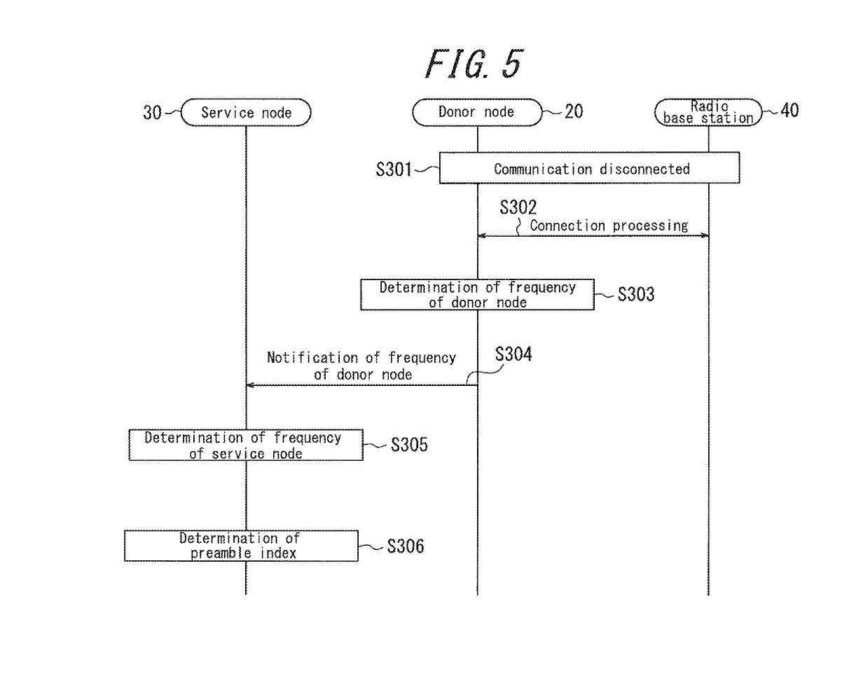

FIG. 5 illustrates sequence for the radio relay apparatus 10 to determine a preamble index at the time of a reconnection.

When the connection between the donor node 20 and the radio base station 40 is disconnected for some reason (step S301), the base station side controller 24 included in the donor node 20 starts connection processing with the radio base station 40 (step S302), and the base station side controller 24 determines a frequency of the donor node 20 (step S303). The subsequent sequence (steps S304-S306) is substantially the same as the steps S204-S206 illustrated in FIG. 4, and a description thereof is omitted.

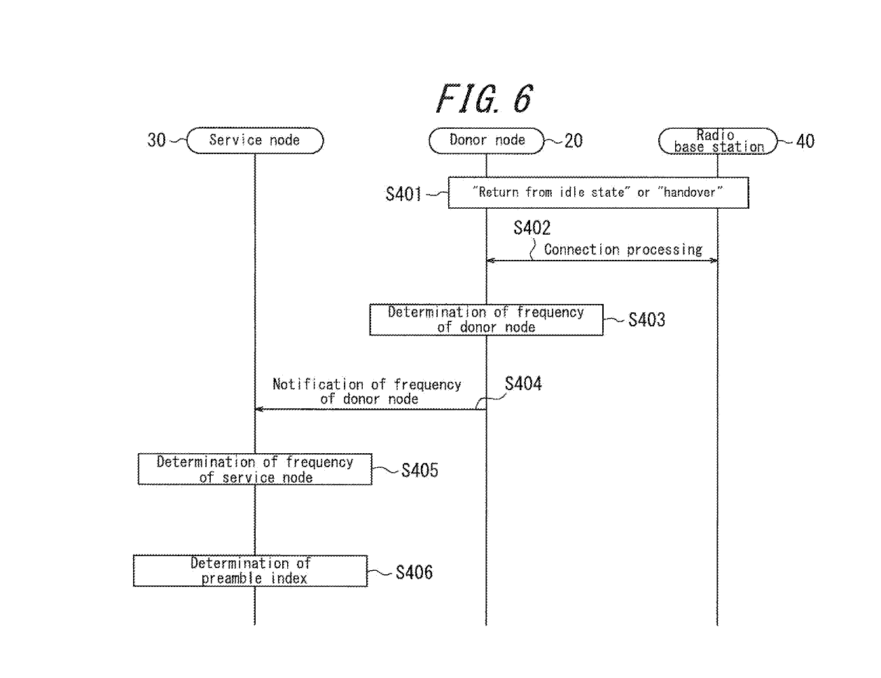

FIG. 6 illustrates sequence for the radio relay apparatus 10 to determine a preamble index at the time of a return from the idle state or a handover.

When a return event from the idle state or a handover event occurs between the donor node 20 and the radio base station 40 (step S401), the base station side controller 24 included in the donor node 20 starts connection processing with the radio base station 40 (step S402), and the base station side controller 24 determines a frequency of the donor node 20 (step S403). The subsequent sequence (steps S404-S406) is substantially the same as the steps S204-S206 illustrated in FIG 4, and a description thereof is omitted.

As described above, according to the present invention, a radio relay apparatus which is capable of automatically determining a value different from the preamble indexes of the peripheral radio base stations to be the preamble index value of the self apparatus, as well as such a radio communication method and such a processor, is provided. As a result, the need for checking the preamble indexes of the peripheral radio base stations is omitted when the radio relay apparatus is disposed, and cell design is simplified. Moreover, work time is decreased when the radio relay apparatus is disposed.

Although the present invention has been described based on the drawings and the embodiments thereof, it should be noted that a person skilled in the art may easily make various changes and modifications according to the present disclosure. Therefore, such changes and modifications are to be understood as included within the scope of the present invention. For example, functions and the like included in various means, steps, or the like may be rendered in any logically consistent way. Furthermore, means and steps may be combined into one or divided.

### REFERENCE SIGNS

10 radio relay apparatus
20 donor node
22 base station side communicator
24 base station side controller
30 service node
32 terminal side communicator
34 terminal side controller

1. A radio relay apparatus which relays radio signals transmitted and received between radio base stations and a radio terminal, comprising:
a terminal side communicator that transmits and receives radio signals to and from the radio terminal;
a base station side communicator which transmits and receives radio signals to and from the radio base stations; and
a controller which sets a first preamble index, which is a preamble index of the radio relay apparatus, and that acquires, from a radio signal received by the base station side communicator from each of the radio base stations, a second preamble index, which is a preamble index of the radio base station, wherein
the controller determines a value different from the second preamble index to be the first preamble index.

2. The radio relay apparatus of claim 1, wherein
the controller is configured to:
set a predetermined initial value as a candidate value for the first preamble index;
compare the candidate value with the second preamble index;
when a result of the comparison indicates that the candidate value is equal to the second preamble index, change the candidate value and compare the changed candidate value with the second preamble index again; and
when the result of the comparison indicates that the candidate value is not equal to the second preamble index, determine the candidate value to be the first preamble index.

3. The radio relay apparatus of claim 2, wherein
the predetermined initial value is calculated from a value of a MAC address of the radio relay apparatus.

4. The radio relay apparatus of claim 1, wherein
the controller is configured to:
set the first preamble index used during a previously established connection as a candidate value for the first preamble index;
compare the candidate value with the second preamble index;
when a result of the comparison indicates that the candidate value is equal to the second preamble index, change the candidate value and compare the changed candidate value with the second preamble index again; and
when the result of the comparison indicates that the candidate value is not equal to the second preamble index, determine the candidate value to be the first preamble index.

5. The radio relay apparatus of claim 1, wherein
the controller determines the first preamble index when detecting a predetermined event.

6. The radio relay apparatus of claim 5, wherein
the detection of the predetermined event comprises detection of an initial connection or a reconnection between the radio relay apparatus and the radio base station.

7. The radio relay apparatus of claim 5, wherein
the detection of the predetermined event comprises detection of a return from an idle state or a handover between the radio relay apparatus and the radio base station.

8. A radio communication method for a radio relay apparatus which relays radio signals transmitted and received between radio base stations and a radio terminal, the radio relay apparatus comprising a terminal side communicator which transmits and receives radio signals to and from the radio terminal, and a base station side communicator that transmits and receives radio signals to and from the radio base stations, the radio communication method comprising the steps of:
acquiring, from a radio signal received by the base station side communicator from each of the radio base stations, a second preamble index, which is a preamble index of the radio base station; and
determining a value different from the second preamble index to be a first preamble index, which is a preamble index of the radio relay apparatus.

9. The radio communication method of claim 8, further comprising the steps of:
setting a predetermined initial value as a candidate value for the first preamble index;
comparing the candidate value with the second preamble index;
when a result of the comparison indicates that the candidate value is equal to the second preamble index, changing the candidate value and comparing the changed candidate value with the second preamble index again; and
when the result of the comparison indicates that the candidate value is not equal to the second preamble index, determining the candidate value to be the first preamble index.

10. The radio communication method of claim 8, further comprising the steps of:
setting the first preamble index used during a previously established connection as a candidate value for the first preamble index;
comparing the candidate value with the second preamble index;
when a result of the comparison indicates that the candidate value is equal to the second preamble index, changing the candidate value and comparing the changed candidate value with the second preamble index again; and
when the result of the comparison indicates that the candidate value is not equal to the second preamble index, determining the candidate value to be the first preamble index.

11. A processor of a radio relay apparatus which relays radio signals transmitted and received between radio base stations and a radio terminal, the processor configured to:
set a first preamble index, which is a preamble index of the radio relay apparatus;
acquire, from a radio signal received from each of the radio base stations, a second preamble index, which is a preamble index of the radio base station; and
determine a value different from the second preamble index to be the first preamble index.

12. The processor of claim 11, further configured to:
set a predetermined initial value as a candidate value for the first preamble index;
compare the candidate value with the second preamble index;
when a result of the comparison indicates that the candidate value is equal to the second preamble index, change the candidate value and compare the changed candidate value with the second preamble index again; and
when the result of the comparison indicates that the candidate value is not equal to the second preamble index, determine the candidate value to be the first preamble index.

13. The processor of claim 11, further configured to:
set the first preamble index used during a previously established connection as a candidate value for the first preamble index;
compare the candidate value with the second preamble index;
when a result of the comparison indicates that the candidate value is equal to the second preamble index, change the candidate value and compare the changed candidate value with the second preamble index again; and
when the result of the comparison indicates that the candidate value is not equal to the second preamble index, determine the candidate value to be the first preamble index.
